(19) United States
(12) Patent Application Publication
(10) Pub. No.: US 2013/0294083 A1
(43) Pub. Date: Nov. 7, 2013

(54) LED Street Lamp with Improved Heat Dissipation

(71) Applicant: Chunzheng Zheng, Guangxi (CN)

(72) Inventor: Chunzheng Zheng, Guangxi (CN)

(73) Assignee: KUAN TECH (BEIHAI) CO., LTD., Beihai, Guangxi (CN)

(21) Appl. No.: 13/390,132

(22) PCT Filed: Jan. 26, 2011
(86) PCT No.: PCT/CN11/70674

§ 371 Date: Feb. 13, 2012

(51) Int. Cl. F21V 29/00; F21S 8/08

(52) U.S. Cl. CPC F21V 29/2243; F21S 8/085
USPC 362/294; 362/382

(57) ABSTRACT

An LED street lamp has a lamp body, at least one LED module and a power supply. The lamp body includes at least one heat dissipating portion and a connecting portion. Each of the at least one heat dissipating portion has two main fins. The main fins are crossed to divide each of the at least one heat dissipating portion into four fan-shaped regions. Each fan-shaped region has multiple auxiliary fins and multiple ventilation channels. Each of the at least one LED module is secured to one of the at least one heat dissipating portion of the lamp body. The power supply is mounted on the connecting portion of the lamp body. With the above-mentioned structure, the LED street lamp can provide improved heat dissipation and dust does not easily accumulate in the ventilation channels.

### BACKGROUND OF THE INVENTION

1. Field of the Invention

The present invention relates to an LED street lamp, and more particularly to an LED street lamp that provides improved heat dissipation and prevents accumulation of dust.

2. Description of the Prior Arts

LED street lamps use light-emitting diodes (LEDs) as sources of light, which have high brightness and low power consumption. LED performance depends on the ambient temperature of the operating environment. Driving an LED in high ambient temperatures may lead to overheating and device failure. Thus, providing a heat sink for dissipating heat from the LED is required to maintain long life of the LED.

A finned heat sink is the most widely used type of heat sink at present. The finned heat sink comprises multiple fins. The heat from a heat source can be transmitted to the fins by heat conduction and then the fins radiate the heat to the air. However, the finned heat sink dissipating the heat only by heat conduction is slow and inefficient.

A conventional heat sink disclosed in China Patent No. 201555047 is a die casting type heat pipe radiator. However, the heat pipe radiator also dissipates heat only by heat conduction, which is slow and inefficient.

Another conventional heat sink disclosed in China Patent No. 201555192 is a radiator having holes. The holes allow air to flow therethrough so as to enhance air convection and heat dissipation. However, dust easily accumulates in the holes, which reduces the heat dissipation. Besides, it is hard to remove the dust accumulating in the holes.

To overcome the shortcomings, the present invention provides an LED street lamp with improved heat dissipation that prevents accumulation of dust to mitigate or obviate the aforementioned problems.

### SUMMARY OF THE INVENTION

The main object of the present invention is to provide an LED street lamp with improved heat dissipation that prevents accumulation of dust.

To achieve the foregoing objective, the LED street lamp in accordance with the present invention comprises a lamp body, at least one LED module and a power supply. The lamp body includes at least one heat dissipating portion and a connecting portion. Each of the at least one heat dissipating portion has a connector and two main fins. The main fins are crossed and the connector serves as a cross center. The main fins divide each of the at least one heat dissipating portion into four fan-shaped regions. Each fan-shaped region has multiple auxiliary fins and multiple ventilation channels. The auxiliary fins are arranged to parallel one another and a side of each auxiliary fin is connected to one of the main fins. Each ventilation channel is formed between two adjacent auxiliary fins and has an open top and an open bottom. The connecting portion is formed on an end of the at least one heat dissipating portion. Each of the at least one LED module is secured to the connector of one of the at least one heat dissipating portion of the lamp body. The power supply is mounted on the connecting portion of the lamp body. With the above-mentioned structure, the LED street lamp can provide improved heat dissipation and dust does not easily accumulate in the ventilation channels. Besides, dust can be conveniently removed even if dust accumulates in the ventilation channels.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of an LED street lamp in accordance with the present invention;

FIG. 2 is a perspective view of the LED street lamp in FIG. 1 without a cover;

FIG. 3 is a perspective view of the LED street lamp in FIG. 1;

FIG. 4 is an exploded perspective view of another embodiment of an LED street lamp in accordance with the present invention;

FIG. 5 is a bottom view of the LED street lamp in FIG. 4;

FIG. 6 is a top view of the LED street lamp in FIG. 4 without a cover;

FIG. 7 is a bottom perspective view of the LED street lamp in FIG. 4; and

FIG. 8 is a top perspective view of the LED street lamp in FIG. 4.

### DETAILED DESCRIPTION OF THE PREFERRED EMBODIMENTS

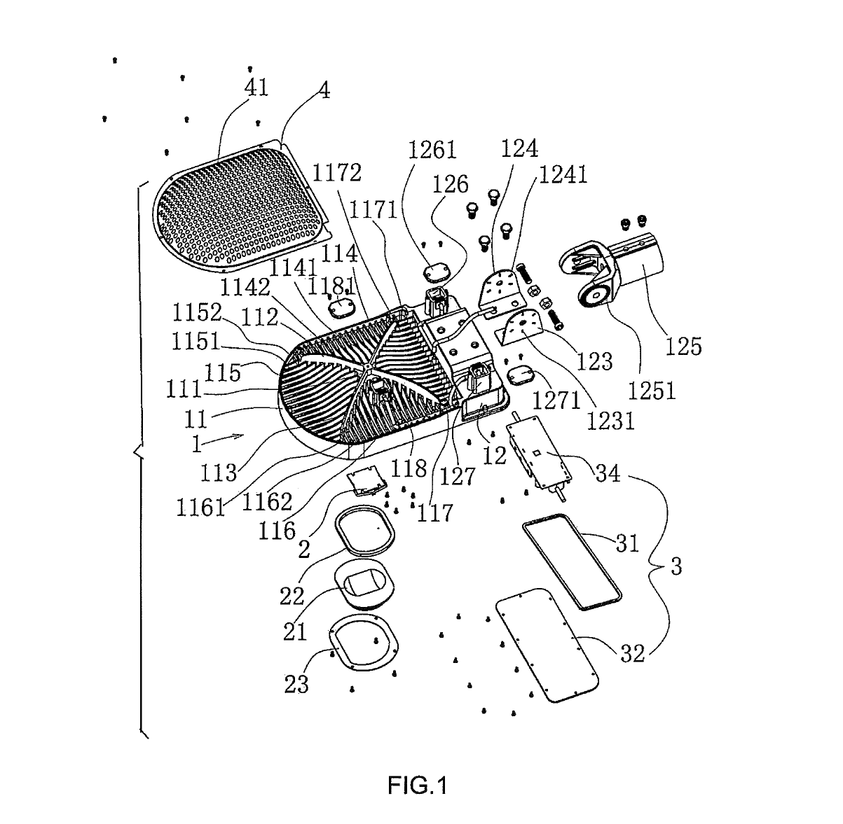

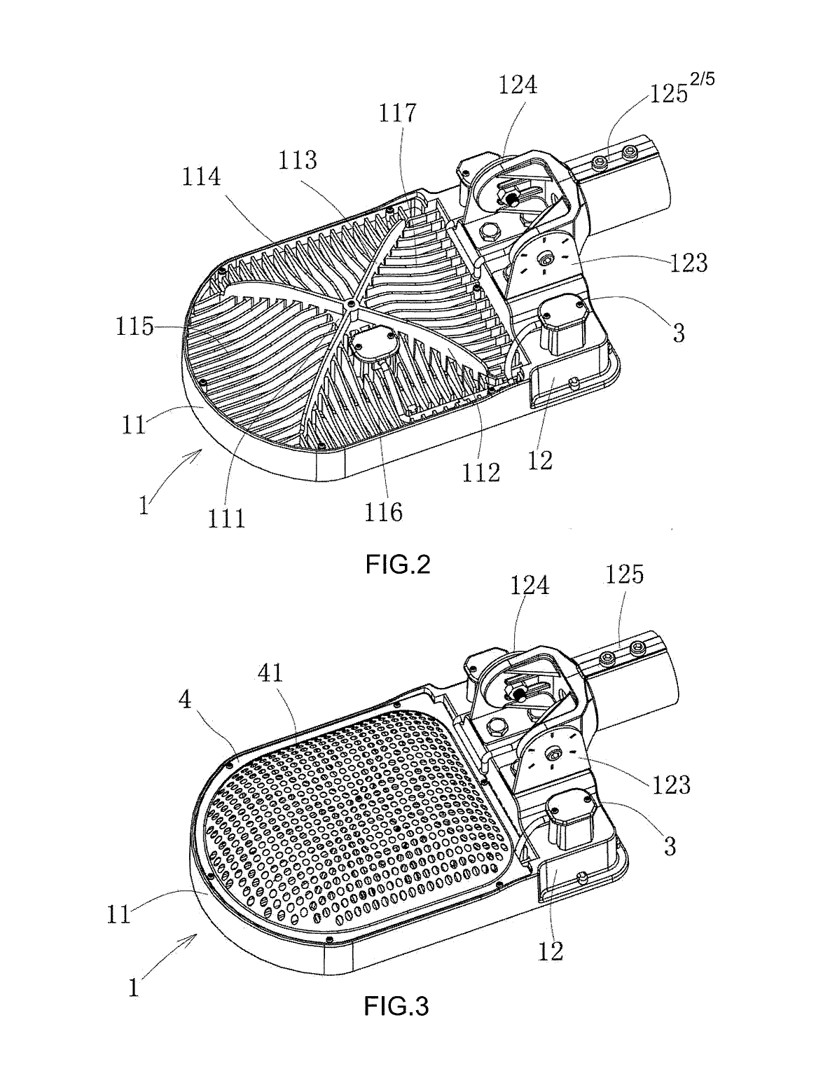

With reference to FIGS. 1 to 3, an LED street lamp with the present invention comprises a lamp body 1, a connecting bracket 125, at least one LED module 2, a power supply 3 and a cover 4.

The lamp body 1 is formed by one-time die casting and includes at least one heat dissipating portion 11 and a connecting portion 12. Each of the at least one heat dissipating portion 11 has a bottom surface, a connector 111 and two main fins 112,113. The connector 111 is made of metal and is rectangular in cross section. Preferably, the connector 111 is made of aluminum alloy. The main fins 112,113 are crossed and the connector 111 serves as a cross center. The main fins 112,113 divide each of the at least one heat dissipating portion 11 into four fan-shaped regions 114,115,116,117. Each fan-shaped region 114,115,116,117 has multiple auxiliary fins 1141,1151,1161,1171 and multiple ventilation channels 1142,1152,1162,1172. The auxiliary fins 1141,1151,1161,1171 of each fan-shaped region 114, 115, 116, 117 are arranged to parallel one another and a side of each auxiliary fin 1141,1151,1161,1171 is connected to one of the main fins 112,113. Each ventilation channel 1142,1152,1162,1172 is elongated, is formed between two adjacent auxiliary fins 1141,1151,1161,1171 and has an open top and an open bottom.

The connecting portion 12 is formed on an end of the at least one heat dissipating portion 11 and has a top surface, two positioning parts 123,124, a first tube 126 and a second tube 127. The positioning parts 123,124 are secured to the top surface of the connecting portion 12 and are spaced at an interval. Each positioning part 123,124 has a rack 1231,1241 mounted thereon.

The first tube 126 and the second tube 127 extend from two sides of the top surface of the connecting portion 12. The first tube 126 is adjacent to the one positioning part 124 for mounting a high voltage cable. The high voltage cable has two ends. One end of the high voltage cable is connected to a mains supply and the other end of the high voltage cable is connected to an input of the power supply 3. The first tube 126 is filled with a sealant and has an open top and a first sealing cap 1261. The first sealing cap 1261 seals the open top of the first tube 126. The second tube 127 is adjacent to the other positioning part 123 for mounting a low voltage cable. The low voltage cable has two ends. One end of the low voltage cable is connected to the LED module 2 and the other end of the low voltage cable is connected to an output of the power supply 3. The second tube 127 is filled with a sealant and has an open top and a second sealing cap 1271. The second sealing cap 1271 seals the open top of the second tube 127. Further, each of the at least one heat dissipating portion 11 has a third tube 118 adjacent to the connector 111 for mounting an LED input line. The LED input line is connected between the low voltage cable and the LED module 2. The third tube 118 is filled with a sealant and has an open top and a third sealing cap 1181. The third sealing cap 1181 seals the open top of the third tube 118.

The connecting bracket 125 is pivotally connected between the positioning parts 123,124 of the lamp body 1 and has two gears 1251 mounted on two side surfaces thereof. Each gear 1251 corresponds to one of the racks 1231,1241 of the positioning parts 123,124 and teeth of the gear 1251 selectively engage teeth of the corresponding rack 1231,1241. Thus, the lamp body 1 can be disposed at different degrees relative to the connecting bracket 125, which is mounted on a lamp post.

Each of the at least one LED module 2 is secured to a bottom surface of the connector 111 of one of the at least one heat dissipating portion 11 of the lamp body 1 and includes an optical lens 21, a first sealing ring 22 and a holding ring 23. The optical lens 21 covers the LED module 2 and is pervious to light. The first sealing ring 22 and the holding ring 23 are mounted on the heat dissipating portion 11 of the lamp body 1 around the optical lens 21 to hold the optical lens 21 in place. In a preferred embodiment, the LED street lamp comprises one heat dissipating portion 11 of the lamp body 1 and one LED module 2.

The power supply 3 is mounted on the connecting portion 12 of the lamp body 1 and includes a second sealing ring 31, a holding board 32 and a constant voltage and current source 34. The second sealing ring 31 and the holding board 32 are mounted on the connecting portion 12 of the lamp body 1 to hold the power supply 3 in place.

The cover 4 covers a top surface of the at least one heat dissipating portion 11 of the lamp body 1 and includes multiple through holes 41. The cover 4 prevents dust, sand or snow from falling directly on the fins 112,113,1141,1151,1161,1171 of the lamp body 1 and reducing the heat dissipation of the fins 112,113,1141,1151,1161,1171.

When the LED street lamp in accordance with the present invention is in use, the connector 111 absorbs heat from the LED module 2 and transmits the heat to the main fins 112,113 and the auxiliary fins 1141,1151,1161,1171 by heat conduction, then the fins 112,113,1141,1151,1161,1171 radiate the heat to the air. Meanwhile, the ventilation channels 1142,1152,1162,1172 allow the air to flow therethrough to enhance air convection. Consequently, the LED street lamp can provide improved heat dissipation. Furthermore, dust does not easily accumulate in the ventilation channels 1142,1152,1162,1172 because the ventilation channels 1142,1152,1162,1172 are elongated and dust can be conveniently removed even if dust accumulates in the ventilation channels 1142,1152,1162,1172.

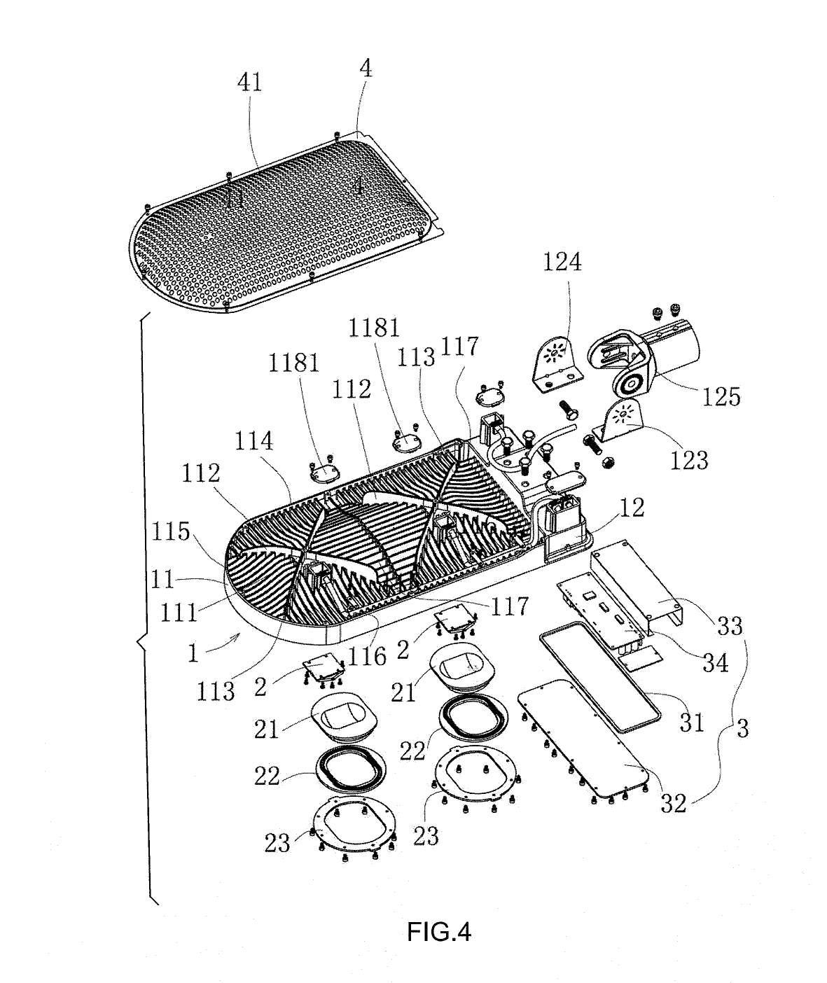

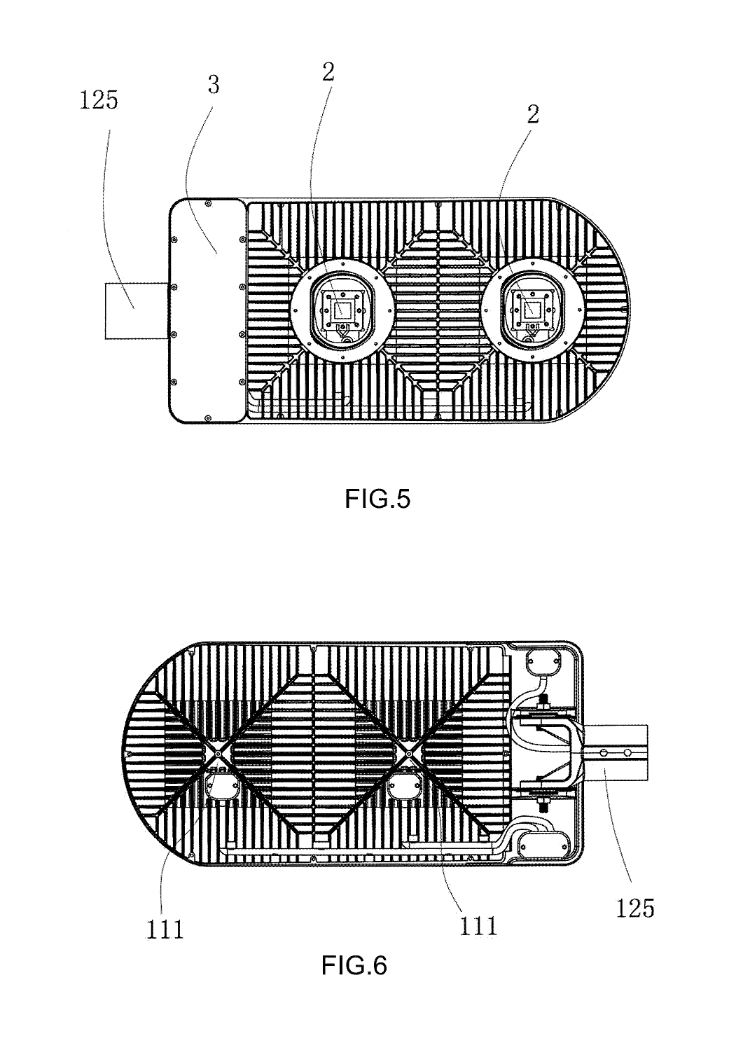

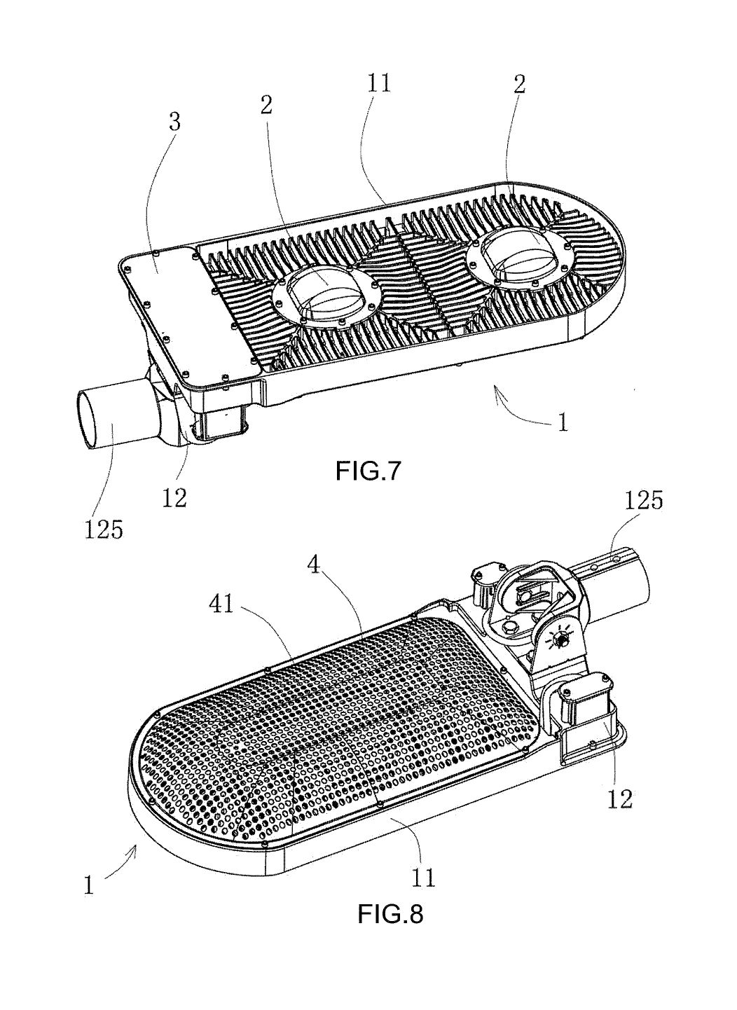

With reference to FIGS. 4 to 8, in another embodiment based on the foregoing embodiment, the LED street lamp comprises two dissipating portions 11 of the lamp body 1 and two LED modules 2, rather than one dissipating portion 11 and one LED module 2. Therefore, the LED street lamp can provide higher brightness and is applicable to a wider road when compared to the foregoing embodiment. Besides, the power supply 3 further includes an insulating frame 33 as shown in FIG. 4. The insulating frame 33 is secured to the connecting portion 12 of the lamp body 1 for receiving the constant voltage and current source 34.

In addition to one or two LED modules 2, the LED street lamp in accordance with the present invention may comprise three, four, five or more LED modules 2.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

1. An LED street lamp comprising:
a lamp body including
at least one heat dissipating portion and each of the at least one heat dissipating portion having
a connector; and
two main fins crossed and the connector serving as a cross center, the main fins dividing each of the at least one heat dissipating portion into four fan-shaped regions and each fan-shaped region having
multiple auxiliary fins arranged to parallel one another and a side of each auxiliary fin connected to one of the main fins; and
multiple ventilation channels and each ventilation channel formed between two adjacent auxiliary fins and having an open top and an open bottom; and
a connecting portion formed on an end of the at least one heat dissipating portion;
at least one LED module and each of the at least one LED module secured to the connector of one of the at least one heat dissipating portion of the lamp body, and
a power supply mounted on the connecting portion of the lamp body.

2. The LED street lamp as claimed in claim 1, wherein the lamp body is formed by one-time die casting.

3. The LED street lamp as claimed in claim 2, wherein
the connecting portion of the lamp body has
a top surface; and
two positioning parts secured to the top surface of the connecting portion and spaced at an interval and each positioning part having a rack mounted thereon; and
the LED street lamp further comprises a connecting bracket pivotally connected between the positioning parts of the lamp body and having two gears mounted on two side surfaces thereof, each gear corresponds to one of the racks of the positioning parts and teeth of the gear selectively engage teeth of the corresponding rack.

4. The LED street lamp as claimed in claim 3, wherein the connecting portion of the lamp body has
a first tube extending from a side of the top surface of the connecting portion adjacent to the one positioning part for mounting a high voltage cable, the high voltage cable having two ends, one end of the high voltage cable connected to a mains supply and the other end of the high voltage cable connected to an input of the power supply; and
a second tube extending from another side of the top surface of the connecting portion adjacent to the other positioning part for mounting a low voltage cable, the low voltage cable having two ends, one end of the low voltage cable connected to the LED module and the other end of the low voltage cable connected to an output of the power supply.

5. The LED street lamp as claimed in claim 4, wherein
the first tube of the connecting portion of the lamp body is filled with a sealant and has
an open top; and
a first sealing cap sealing the open top of the first tube; and
the second tube of the connecting portion of the lamp body is filled with a sealant and has
an open top; and
a second sealing cap sealing the open top of the second tube.

6. The LED street lamp as claimed in claim 5, wherein each of the at least one LED module includes
an optical lens covering the LED module; and
a first sealing ring and a holding ring mounted on the heat dissipating portion of the lamp body around the optical lens.

7. The LED street lamp as claimed in claim 6, wherein each of the at least one heat dissipating portion of the lamp body has a third tube adjacent to the connector for mounting an LED input line connected between the low voltage cable and the LED module.

8. The LED street lamp as claimed in claim 7, wherein the third tube of each of the at least one heat dissipating portion of the lamp body is filled with a sealant and has
an open top; and
a third sealing cap sealing the open top of the third tube.

9. The LED street lamp as claimed in claim 8 further comprising a cover covering a top surface of the at least one heat dissipating portion of the lamp body and including multiple through holes.

10. The LED street lamp as claimed in claim 1, wherein the connector of each of the at least one heat dissipating portion of the lamp body is made of metal and is rectangular in cross section.

11. The LED street lamp as claimed in claim 1, wherein
the connecting portion of the lamp body has
a top surface; and
two positioning parts secured to the top surface of the connecting portion and spaced at an interval and each positioning part having a rack mounted thereon; and
the LED street lamp further comprises a connecting bracket pivotally connected between the positioning parts of the lamp body and having two gears mounted on two side surfaces thereof, each gear corresponds to one of the racks of the positioning parts and teeth of the gear selectively engage teeth of the corresponding rack.

12. The LED street lamp as claimed in claim 11, wherein the connecting portion of the lamp body has
a first tube extending from a side of the top surface of the connecting portion adjacent to the one positioning part for mounting a high voltage cable, the high voltage cable having two ends, one end of the high voltage cable connected to a mains supply and the other end of the high voltage cable connected to an input of the power supply; and
a second tube extending from another side of the top surface of the connecting portion adjacent to the other positioning part for mounting a low voltage cable, the low voltage cable having two ends, one end of the low voltage cable connected to the LED module and the other end of the low voltage cable connected to an output of the power supply.

13. The LED street lamp as claimed in claim 12, wherein
the first tube of the connecting portion of the lamp body is filled with a sealant and has
an open top; and
a first sealing cap sealing the open top of the first tube; and
the second tube of the connecting portion of the lamp body is filled with a sealant and has
an open top; and
a second sealing cap sealing the open top of the second tube.

14. The LED street lamp as claimed in claim 13, wherein each of the at least one LED module includes
an optical lens covering the LED module; and
a first sealing ring and a holding ring mounted on the heat dissipating portion of the lamp body around the optical lens.

15. The LED street lamp as claimed in claim 14, wherein each of the at least one heat dissipating portion of the lamp body has a third tube adjacent to the connector for mounting an LED input line connected between the low voltage cable and the LED module.

16. The LED street lamp as claimed in claim 15, wherein the third tube of each of the at least one heat dissipating portion of the lamp body is filled with a sealant and has
an open top; and
a third sealing cap sealing the open top of the third tube.

17. The LED street lamp as claimed in claim 16 further comprising a cover covering a top surface of the at least one heat dissipating portion of the lamp body and including multiple through holes.
